(19) United States
(12) Patent Application Publication
(10) Pub. No.: US 2013/0251160 A1
(43) Pub. Date: Sep. 26, 2013

(54) PURE TONE TEST APPARATUS AND METHOD FOR CONTROLLING THE SAME

(71) Applicants: Young Kwan Lee, Gyunggi-do (KR); Sun Kim, Gyunggi-do (KR)

(72) Inventors: Young Kwan Lee, Gyunggi-do (KR); Sun Kim, Gyunggi-do (KR)

(73) Assignee: SAMSUNG ELECTRO-MECHANICS CO., LTD., SUWON-SI (KR)

(21) Appl. No.: 13/464,684

(22) Filed: May 4, 2012

(30) Foreign Application Priority Data
Mar. 20, 2012 (KR) 1020120028273

(51) Int. Cl. H04R 29/00

(52) U.S. Cl. 381/58

(57) ABSTRACT

Disclosed herein is a pure tone test apparatus including: a stage including a support supporting a pure tone test target; a support plate mounted on one side of the stage and having a guide mounted on a front surface thereof; an acoustic detection unit movably mounted on the guide and being engaged with the support to detect noise generated from the target; a control unit connected with the guide, the acoustic detection unit, and the support to control a pure tone test; and a display unit displaying a pure tone test result detected by the control of the control unit.

### CROSS REFERENCE TO RELATED APPLICATION

This application claims the benefit of Korean Patent Application No. 10-2012-0028273, filed on Mar. 20, 2012, entitled “Pure Tone Test Apparatus and Control Method Thereof”, which is hereby incorporated by reference in its entirety into this application.

### BACKGROUND OF THE INVENTION

1. Technical Field

The present invention relates to a pure tone test apparatus and a method for controlling the same.

2. Description of the Related Art

Most electronic devices, or the like, may generate large and small driving noise in terms of characteristics of a structure thereof. In worse case scenarios, the driving noise from electronic devices, or the like, may cause pain and stress to users. Therefore, minimizing the driving noise of electronic devices, or the like, is one of the fundamental problems to be solved in order to improve the quality of human life. Recently, various devices have been developed or various methods have been attempted to minimize the noise.

Meanwhile, in order to efficiently reduce the noise, there is a need to generate reliable noise information by accurately measuring noise from noise sources. However, as described in Korean Laid-Open Patent No. 2005-0119290 (Publication in Dec. 21, 2005) as the prior art, an anechoic room for professionally measuring and evaluating noise should be included in order to evaluate pure tone noise of electronic devices such as a hard disk drive (HDD).

A noise degree of products has been evaluated in a state in which the anechoic room is included along with various noise measuring devices that also need to be included so as to meet the international standards. Even though the noise evaluation method for products has high accuracy, the noise evaluation method has problems in that considerable costs are consumed and it requires a lot of time and effort. In particular, for mass production, it is impossible to test all the products one by one and it is difficult to evaluate the noise from products using only the sampling test.

In addition, when objects causing noise such as a computer, or the like, are present around the anechoic room, the noise evaluation method in accordance with the prior art may distort the pure tone of products.

In particular, since the measurement distance between a product and a microphone is spaced apart from each other in the anechoic room, the sound quality evaluation may greatly change according to conditions and situations, and thus, noise cannot be objectively measured.

### SUMMARY OF THE INVENTION

The present invention has been made in an effort to provide a pure tone test apparatus capable of easily testing a pure tone test of electronic devices during a production process.

In addition, the present invention has been made in an effort to provide a method for controlling a pure tone test apparatus capable of measuring only pure tone noise of electronic devices by blocking background noises as maximally as possible.

According to a preferred embodiment of the present invention, there is provided a pure tone test apparatus, including: a stage including a support supporting to a pure tone test target; a support plate mounted on one side of the stage and having a guide mounted on a front surface thereof; an acoustic detection unit movably mounted on the guide and being engaged with the support to detect noise generated from the target; a control unit connected with the guide, the acoustic detection unit, and the support to control a pure tone test; and a display unit displaying a pure tone test result detected by the control of the control unit.

The pure tone test apparatus may further include: soundproof plates mounted at both sides of the stage based on the support.

The support may be formed to be sealed by being engaged with the acoustic detection unit and to connect a power supply to the pure tone test target.

The acoustic detection unit may include: a microphone detecting the noised generated from the pure tone test target; a housing having sides surrounding the microphone and including a drawing hole through which a cable line connected to the microphone is drawn; and an opened type shielding cover extendedly formed integrally from a lower opening part of the housing.

The pure tone test apparatus may further include: sound absorbing and insulating parts mounted on both sides of the housing and including a soundproof material and sound absorbing material provided therein, the soundproof material blocking background noise therein and the sound absorbing material absorbing noise caused by the reflection and overlapping transfer of the noise from the target from an inner surface of the housing.

According to another preferred embodiment of the present invention, there is provided a method for controlling a pure tone test apparatus, including: generating noise by supporting a pure tone test target on a support and supplying power thereto and forming a shielding space by engaging a shielding cover of an acoustic detection unit with the support; detecting noise generated from the target through a microphone of the acoustic detection unit; transforming, by a control unit, detected noise information into replacing acoustic information by using an acoustic compensation algorithm; determining, by the control unit, whether a spectrum according to the replacing acoustic information has a value larger than that of a spectrum of a transfer function from the target to a noise detector in an anechoic room; setting, by the control unit, an evaluation reference spectrum for evaluating the pure tone of the target according to a result of the determining; and performing, by the control unit, the pure tone evaluation of the target by using a prominence ratio (PR) value calculated for the pure tone evaluation of the target.

At the transforming of the replacing acoustic information, the acoustic compensation algorithm may satisfy a relationship equation of

$$\begin{matrix}{G}_{{jj}_{A}} ( f ) = {r}_{jb}^{2} ( f ) \times {G}_{{bb}_{A}} ( f ) \\ = \frac{{H}_{ij}}{{H}_{ab}} \times {G}_{{bb}_{A}} ( f ) .\end{matrix}$$

(where Gⱼⱼ_{_{A}}(f) represents a spectrum according to the replacing acoustic information, r_{jb}² represents an output spectrum correlation coefficient between the anechoic room in accordance with the related art and the shielding space, G_{bb}_{_{A}}(f) represents a noise output spectrum of the target included in the shielding space between the support and the shielding cover, Hᵢⱼ represents a transfer function from the target to a noise detector in the anechoic room in accordance with the related art, and H_{ab} represents a transfer function from the target to a microphone in the shielding space).

The setting of the evaluation reference spectrum may include defining, by the control unit, the spectrum according to the replacing acoustic information as an evaluation reference spectrum for evaluating the pure tone of the target if it is determined that the spectrum according to the replacing acoustic information has a value larger than that of the spectrum of the transfer function from the target to the noise detector in the anechoic room.

The setting of the evaluation reference spectrum may include making, by the control unit, the value of the spectrum according to the replacing acoustic information and the value of the spectrum of the transfer function from the target to the noise detector in the anechoic room equal to each other, if it is determined that the spectrum according to the replacing acoustic information has a value equal to or smaller than that of the spectrum of the transfer function from the target to the noise detector in the anechoic room; and defining, by the control unit, the equalized spectrum as the evaluation reference spectrum for evaluating the pure tone of the target.

At the performing of the pure tone evaluation, the pure tone evaluation of the target may be performed by using the PR value for a critical band of the evaluation reference spectrum.

At the performing of the pure tone evaluation, the pure tone evaluation of the target may be performed by using the PR value through octave analysis on the evaluation reference spectrum.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram for describing a configuration of a pure tone test apparatus in accordance with a preferred embodiment of the present invention;

FIG. 2 is an enlarged perspective view of an acoustic detection unit of the pure tone test apparatus shown in FIG. 1;

FIG. 3 is a flow chart for describing a method for controlling a pure tone test apparatus in accordance with another preferred embodiment of the present invention;

FIG. 4A is a diagram showing an acoustic spectrum detected by the method for controlling a pure tone test apparatus in accordance with another preferred embodiment of the present invention;

FIG. 4B is a diagram showing a spectrum obtained by processing the acoustic spectrum detected by the method for controlling a pure tone test apparatus in accordance with another preferred embodiment of the present invention using an acoustic algorithm; and

FIG. 5 is an acoustic spectrum measured in the real anechoic room.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the accompanying drawings.

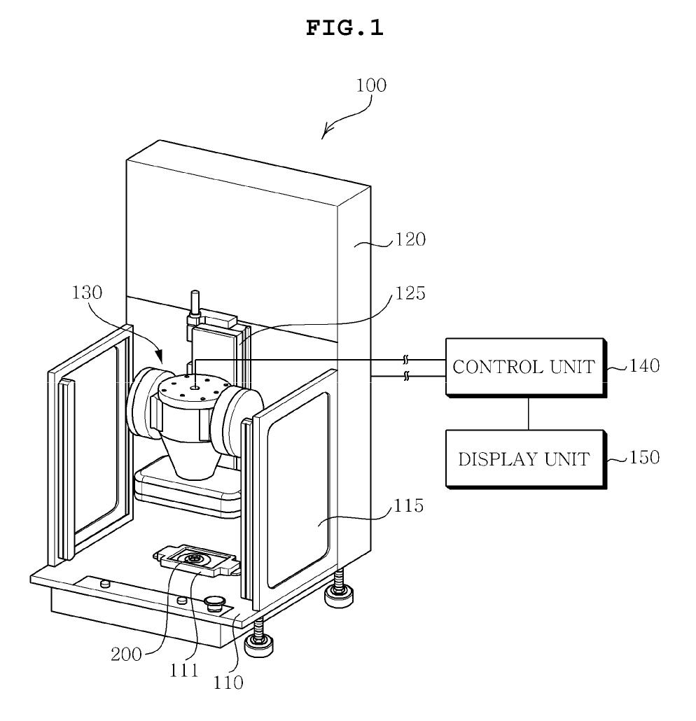

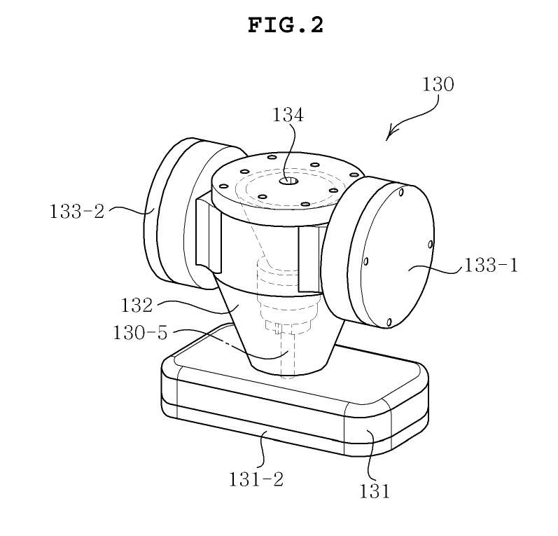

FIG. 1 is a diagram for describing a configuration of a pure tone test apparatus in accordance with a preferred embodiment of the present invention and FIG. 2 is an enlarged perspective view of an acoustic detection unit of the pure tone test apparatus shown in FIG. 1.

A pure tone test apparatus 100 in accordance with a preferred embodiment of the present invention includes a stage 110 having a support 111 supporting a pure tone test target 200 disposed on a top surface thereof, soundproof plates 115 disposed at both sides of the stage 110 based on the support 111, a support plate 120 disposed on a back of the stage 110 and having a guide 125 disposed on a front surface thereof, an acoustic detection unit 130 vertically movable fastened with the guide 125 and engaged with the support 111 to detect noises generated from the pure tone test target 200, a control unit 140 connected to a guide 125, an acoustic detection unit 130, the support 111, or the like, to control the pure tone test, and a display unit 150 displaying results detected by the control of the control unit 140.

The support 111 is a portion that is mounted on a top surface of the stage 110 for supporting a pure tone test target 200, for example, a product mounted with a motor, such as, a hard disk drive (HDD), an optical disc drive (ODD), or the like, or a motor. The support 111 may have a form supported to surround the pure tone test target 200 and may have a sealed structure in which the top thereof is engaged with the acoustic detection unit 130. In this configuration, the support 111 selectively interworks with a conveyor belt or a transfer robot and is thus continuously supported with a product that is the pure tone test target 200 during mass production. Therefore, the product may be tested and separated on and from the support 111.

The guide 125 is mounted on the front of the support plate 120 that is mounted on the back of the stage 110 and a rail or a concave groove line formed at one side thereof is fastened with the acoustic detection unit 130 and the guide 125 may vertically move the acoustic detection unit 130 using a roller or a bearing by a hydraulic or pneumatic sliding manner.

As shown in FIG. 2, the acoustic detection unit 130 includes a microphone 130-5 detecting the noise generated from the pure tone test target 200, a housing 132 having sides surrounding the microphone 130-5 and having one side thereof including a drawing hole 134 through which a cable line connected with the microphone 130-5 is drawn, an opened type shielding cover 131 extendedly formed integrally from a lower opening part of the housing 132, and sound absorbing and insulating parts 133-1 and 133-2 selectively mounted at both sides of the housing 132.

The microphone 130-5 is disposed on a housing 132 at a distance from the lower opening part of the housing 132 so as to detect the noise generated from the target 200 and is connected with the cable line drawn in through the drawing hole 134 to be operated according to a control of the control unit 140.

The shielding cover 131 is engaged with the outside of the support 111 by extending the lower opening part of the housing 132 and forms a shielding space surrounding the target 200 together with the support 111. In addition, a lower edge 131-2 of the shielding cover 132 is made of an elastic material such as rubber, silicon, or the like, to reduce impact and improve shielding efficiency of a shielding space during the engagement with the support 111. Further, the shielding cover 131 in addition to the lower edge 131-2 of the shielding cover 131 may be made of the elastic material such as rubber, silicon, or the like.

The sound absorbing and insulating parts 133-1 and 133-2 are selectively mounted at both sides of the housing 132 as the left sound absorbing and insulating part 133-1 and the right sound absorbing and insulating part 133-2 and the inside thereof is provided with a soundproof material that blocks background noise rather than the noise from the target 200 and a sound absorbing material that absorbs noise generated due to the reflection and overlapping transfer of the noise generated from the target 200 from the inside of the housing 132.

The control unit 140 is connected with the guide 125, the acoustic detection unit 130, the support 111, or the like, and may be mounted the outside or at one side of the support plate 120. The control unit 140 controls the pure tone test to transform the noise from the target 200 detected by the acoustic detection unit 130 using an acoustic algorithm, calculates a prominence ratio (PR) value using the transformed results, and displays the pure tone evaluation of the target 200 on the display unit 150 according to the calculated PR value.

The pure tone test apparatus 100 described as above in accordance with the preferred embodiment of the present invention performs the noise measurement for the target 200 in the shielding space formed by the support 111 and the shielding cover 131 so as to prevent noise from being introduced from the outside. To this end, the pure tone test apparatus 100 supports the target 200 on the support 111 and supplies power to the target 200.

Therefore, the pure tone test apparatus 100 in accordance with the preferred embodiment of the present invention uses the PR value obtained by transforming the detected noise of the target 200 according to the acoustic algorithm without performing the pure tone evaluation in the expensive anechoic room in accordance with the related art, thereby easily performing the pure tone evaluation of the target 200.

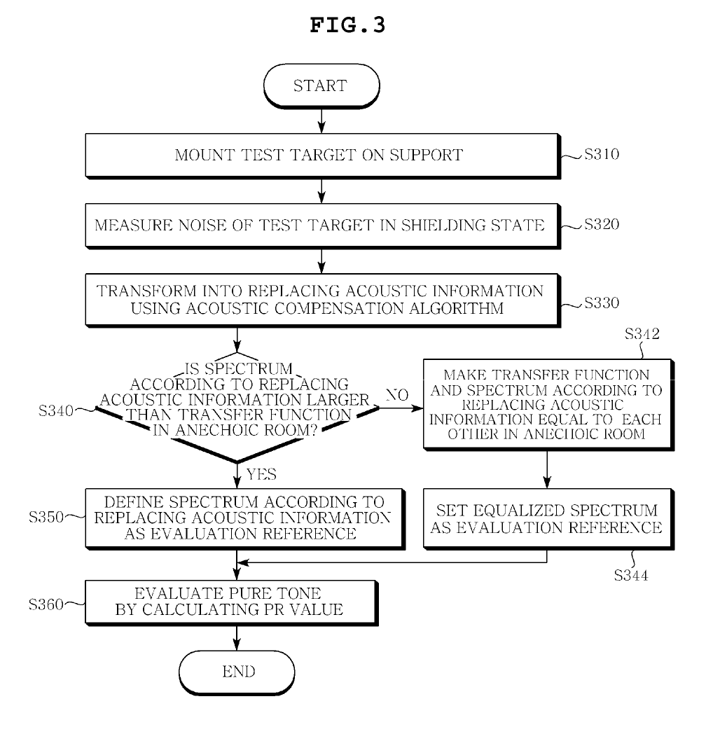

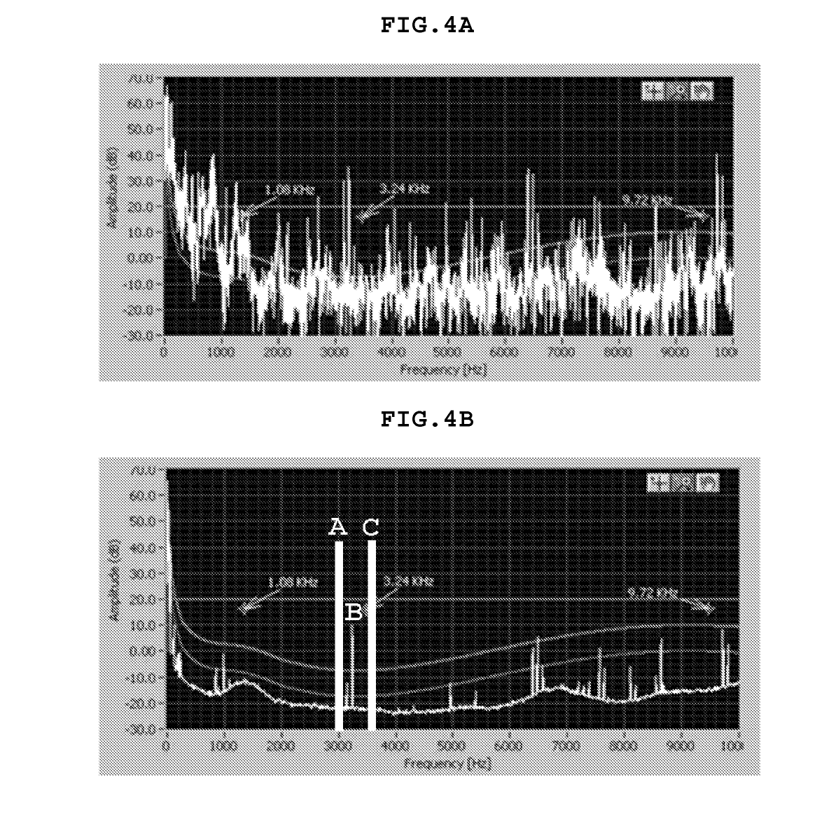

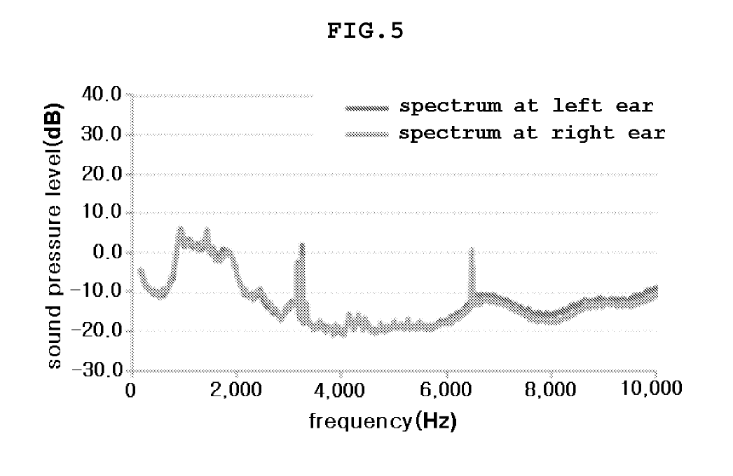

Hereinafter, a method for controlling the pure tone test apparatus for performing the pure tone evaluation of the target 200 in accordance with another preferred embodiment of the present invention will be described with reference to FIGS. 3 to 5. FIG. 3 is a flow chart for describing a method for controlling a pure tone test apparatus in accordance with another preferred embodiment of the present invention, FIG. 4A is a diagram showing an acoustic spectrum detected by the method for controlling a pure tone test apparatus in accordance with another preferred embodiment of the present invention, FIG. 4B is a diagram showing a spectrum obtained by processing the acoustic spectrum detected by the method for controlling a pure tone test apparatus in accordance with another preferred embodiment of the present invention using an acoustic algorithm, and FIG. 5 is an acoustic spectrum measured in the real anechoic room.

As shown in FIG. 3, the method for controlling a pure tone test apparatus for performing the pure tone evaluation of the target 200 in accordance with another preferred embodiment of the present invention first supports the target 200 on the support 111 and supplies power to the target 200 to generate noise therefrom (S310).

That is, the products mounted with a motor such as HDD, ODD, or the like, or the target 200 including a motor is supported on the support 111 and power is supplied to the target 200 so as to be mounted.

As described above, since the target 200 is mounted on the support 111, the target 200 generates noise. In this case, the shielding cover 131 of the acoustic detection unit 130 disposed over the support 111 is engaged with the support 111 according to the control of the control unit 140 to form the shielding space.

After shielding cover 131 is engaged with the support 111 to form the shielding space, the control unit 140 controls the acoustic detection unit 130 to detects the noise generated from the target 200 trough the microphone 130-5 (S320).

In this case, in order for the microphone 130-5 spaced apart from the shielding space to accurately detect the noise generated from the target 200, the sound absorbing and insulating parts 133-1 and 133-2 may be selectively provided so as to prevent the noise generated due to the reflection and overlapping transfer of the external noise or the noise from the target 200 from the inner surface of the housing 132 from incoming into the microphone 130-5.

According to the detection of the noise generated from the target 200 through the microphone 130-5, the control unit 140 transforms the noise information detected using the acoustic compensation algorithm into the replaceable acoustic information (S330).

In detail, the acoustic compensation algorithm is represented by the relationship Equation described in the following [Equation 1].

$$\begin{matrix}{G}_{{jj}_{A}} ( f ) = {r}_{jb}^{2} ( f ) \times {G}_{{bb}_{A}} ( f ) \\ = \frac{{H}_{ij}}{{H}_{ab}} \times {G}_{{bb}_{A}} ( f )\end{matrix}$$

(Gⱼⱼ_{_{A}}(f) represents a spectrum according to the replacing acoustic information, r_{jb}² represents an output spectrum correlation coefficient between the anechoic room, G_{bb}_{_{A}}(f) represents a noise output spectrum of the target 200 included in the shielding space between the support 111 and the shielding cover 131, Hᵢⱼ represents a transfer function from the target 200 to a noise detector (microphone) in the anechoic room in accordance with the related art, and H_{ab} represents a transfer function from the target 200 to the microphone 130-5 in the shielding space).

In the above Equation, the transfer function H is a function representing the relationship between an input wave and an output wave generally having linear characteristics. That is, as represented by the following [Equation 2], the transfer function (H) is defined by a ratio of a Laplace transform Y(s) of an output wave y(t) to a Laplace transform X(s) of the input wave x(t).

$$H ( s ) = \frac{Y ( s )}{X ( s )} \\ X ( s ) = ℒ \{ x ( t ) \} {=}^{def} {\int }_{- ∞}^{∞} x ( t ) {e}^{- st} d t \\ Y ( s ) = ℒ \{ y ( t ) \} {=}^{def} {\int }_{- ∞}^{∞} y ( t ) {e}^{- st} d t \\ x ( t ) = X {e}^{j ω t} = \vert X \vert {e}^{j ( ω t + arg ( X ) )} \\ y ( t ) = Y {e}^{j ω t} = \vert Y \vert {e}^{j ( ω t + arg ( Y ) )} \qquad [ Equation 2 ]$$

(|X| (represents an amplitude, ω represents an angular frequency, and arg(X) and arg(Y) represents a phase)

The control unit 140 transforms the noise spectrum of the target 200 detected by the microphone 130-5 shown in FIG. 4A into the compensation spectrum according to the replacing acoustic information as shown in FIG. 4B by using the acoustic compensation algorithm including the transfer function H.

After transforming the detected noise information into the compensation spectrum according to the replacing acoustic information, the control unit 140 determines whether the spectrum Gⱼⱼ_{_{A}}(f) according to the replacing acoustic information has a value larger than the spectrum of the transfer function Hᵢⱼ from the target 200 to the noise detector (microphone) in the anechoic room in accordance with the related art (S340).

If it is determined that the spectrum Gⱼⱼ_{_{A}}(f) according to the replacing acoustic information has a value larger than the spectrum of the transfer function Hᵢⱼ from the target 200 to the noise detector (microphone) in the anechoic room, the control unit 140 defines the spectrum Gⱼⱼ_{_{A}}(f) according to the replacing acoustic information as an evaluation criterion for evaluating the pure tone of the target 200 (S350).

On the other hand, if it is determined that the spectrum Gⱼⱼ_{_{A}}(f) according to the replacing acoustic information has a value equal to or smaller than the spectrum of the transfer function Hᵢⱼ from the target 200 to the noise detector (microphone) in the anechoic room, the control unit 140 makes the value of the spectrum Gⱼⱼ_{_{A}}(f) according to the replacing acoustic information and the value of the spectrum of the transfer function Hᵢⱼ from the target 200 to the noise detector (microphone) in the anechoic room equal to each other (S342).

For example, as a result of comparing the spectrum Gⱼⱼ_{_{A}}(f) according to the replacing acoustic information shown in FIG. 4B with the spectrum of the transfer function Hᵢⱼ from the target 200 to the noise detector (microphone) in the anechoic room shown in FIG. 5, these spectrum waveforms are similar to each other or have insignificant difference or are the same as each other. Therefore, the control unit 140 may equalize the value of the spectrum shown in FIG. 4B and the value of the spectrum shown in FIG. 5 as the same spectrum as each other.

Therefore, the control unit 140 uses the equalized spectrum as an evaluation criterion for evaluating the pure test one of the target 200 (S344).

As described above, the pure tone evaluation of the target is performed by the prominence ratio (PR) value calculated by using the equalized spectrum defined at S344 or the spectrum Gⱼⱼ_{_{A}}(f) according to the replacing acoustic information defined at S350 as the evaluation criterion for evaluating the pure tone of the target 200 (S360).

Here, the pure tone evaluation of the target 200 by the PR value may be largely classified into two evaluation methods, that is, a method using a critical band and a method using octave analysis.

The method for evaluating the pure tone using the critical band may calculate a difference value in average values of sound pressure levels at the critical band of both sides of the target 200 represented by “A” and “C” for the sound pressure level of the critical band including the pure tone component of the target 200 represented by “B” as the PR value in the spectrum of the evaluation criterion shown in FIG. 4B.

For example, in FIG. 4B, the sound pressure level of the critical band of 3.24 KHz including the pure tone component of the target 200 represented by “B” is 10 dB and the average value of the sound pressure levels at the critical band of both sides thereof represented by “A” and “C” is −23 dB, such that the PR value of the target 200 is calculated as 33 dB. The PR value of 33 dB, which is a high numerical value corresponding to the noise level in which the pure tone of the target 200 is out of an allowable PR range, may evaluate the pure tone of the target 200 as a defect.

In this case, the allowable PR range for evaluating the pure tone of the target 200 may be different according to the device of the target 200.

Unlike this, the control unit 140 may calculate the continuous PR value by ⅓ octave analysis or 1/12 octave analysis so as to evaluate the pure tone at a low frequency domain less than 1 KHz.

The octave analysis is one of the frequency analysis methods that pass through the measured time signals in 33 frequency bands and calculate the PR size. For example, a ⅓ octave band exponentially divides again a section of a start frequency and a terminal frequency that is two times higher than the start frequency in a band, like 500 Hz to 1000 Hz and 1000 Hz to 2000 Hz, into three sections.

Therefore, the ⅓ octave analysis is a method of analyzing the PR value by using a frequency band having the relatively narrow frequency interval in the case of the low frequency and the relatively wide frequency interval in the case of the high frequency. Further, the 1/12 octave analysis exponentially divides the start frequency and the terminal frequency that is two times higher than the start frequency into 12 sections to analyze the PR value in each frequency band.

Therefore, the method for controlling a pure tone test apparatus for performing the pure tone evaluation of the target 200 in accordance with another preferred embodiment of the present invention calculates and analyzes the PR value for the spectrum obtained by transforming the detected noise from the target 200 according to the acoustic algorithm to easily perform the pure ton evaluation of the target 200.

The pure tone test apparatus in accordance with the preferred embodiments of the present invention can easily perform the pure tone evaluation of the target using the PR value calculated by transforming the detection noise of the target according to the acoustic algorithm without performing the pure tone evaluation in the expensive anechoic room in accordance with the prior art.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A pure tone test apparatus, comprising:
a stage including a support supporting a pure tone test target;
a support plate mounted on one side of the stage and having a guide mounted on a front surface thereof;
an acoustic detection unit movably mounted on the guide and being engaged with the support to detect noise generated from the target;
a control unit connected with the guide, the acoustic detection unit, and the support to control a pure tone test; and
a display unit displaying a pure tone test result detected by the control of the control unit.

2. The pure tone test apparatus as set forth in claim 1, further comprising: soundproof plates mounted at both sides of the stage based on the support.

3. The pure tone test apparatus as set forth in claim 1, wherein the support is formed to be sealed by being engaged with the acoustic detection unit and to connect a power supply to the pure tone test target.

4. The pure tone test apparatus as set forth in claim 1, wherein the acoustic detection unit includes:
a microphone detecting the noised generated from the pure tone test target;
a housing having sides surrounding the microphone and including a drawing hole through which a cable line connected to the microphone is drawn; and
an opened type shielding cover extendedly formed integrally from a lower opening part of the housing.

5. The pure tone test apparatus as set forth in claim 4, further comprising: sound absorbing and insulating parts mounted on both sides of the housing and including a soundproof material and sound absorbing material provided therein, the soundproof material blocking background noise therein and the sound absorbing material absorbing noise caused by the reflection and overlapping transfer of the noise from the target from an inner surface of the housing.

6. A method for controlling a pure tone test apparatus, comprising:
generating noise by supporting a pure tone test target on a support and supplying power thereto and forming a shielding space by engaging a shielding cover of an acoustic detection unit with the support;
detecting noise generated from the target through a microphone of the acoustic detection unit;
transforming, by a control unit, detected noise information into replacing acoustic information by using an acoustic compensation algorithm;
determining, by the control unit, whether a spectrum according to the replacing acoustic information has a value larger than that of a spectrum of a transfer function from the target to a noise detector in an anechoic room;
setting, by the control unit, an evaluation reference spectrum for evaluating the pure tone of the target according to a result of the determining; and
performing, by the control unit, the pure tone evaluation of the target by using a prominence ratio (PR) value calculated for the pure tone evaluation of the target.

7. The method as set forth in claim 6, wherein at the transforming of the replacing acoustic information, the acoustic compensation algorithm satisfies a relationship equation of
$$\begin{matrix}{G}_{{jj}_{A}} ( f ) = {r}_{jb}^{2} ( f ) \times {G}_{{bb}_{A}} ( f ) \\ = \frac{{H}_{ij}}{{H}_{ab}} \times {G}_{{bb}_{A}} ( f ) .\end{matrix}$$
(where Gⱼⱼ_{_{A}}(f) represents a spectrum according to the replacing acoustic information, r_{jb}² represents an output spectrum correlation coefficient between the anechoic room in accordance with the prior art and the shielding space, G_{bb}_{_{A}}(f) represents a noise output spectrum of the target included in the shielding space between the support and the shielding cover, Hᵢⱼ represents a transfer function from the target to a noise detector in the anechoic room in accordance with the related art, and H_{ab} represents a transfer function from the target to a microphone in the shielding space).

8. The method as set forth in claim 6, wherein the setting of the evaluation reference spectrum includes defining, by the control unit, the spectrum according to the replacing acoustic information as an evaluation reference spectrum for evaluating the pure tone of the target if it is determined that the spectrum according to the replacing acoustic information has a value larger than that of the spectrum of the transfer function from the target to the noise detector in the anechoic room.

9. The method as set forth in claim 6, wherein the setting of the evaluation reference spectrum includes:
making, by the control unit, the value of the spectrum according to the replacing acoustic information and the value of the spectrum of the transfer function from the target to the noise detector in the anechoic room equal to each other, if it is determined that the spectrum according to the replacing acoustic information has a value equal to or smaller than that of the spectrum of the transfer function from the target to the noise detector in the anechoic room; and
defining, by the control unit, the equalized spectrum as the evaluation reference spectrum for evaluating the pure tone of the target.

10. The method as set forth in claim 6, wherein at the performing of the pure tone evaluation, the pure tone evaluation of the target is performed by using the PR value for a critical band of the evaluation reference spectrum.

11. The method as set forth in claim 6, wherein at the performing of the pure tone evaluation, the pure tone evaluation of the target is performed by using the PR value through octave analysis on the evaluation reference spectrum.
